(19) United States
(12) Patent Application Publication
(10) Pub. No.: US 2022/0011711 A1
(43) Pub. Date: Jan. 13, 2022

(54) IMAGE FORMING APPARATUS

(71) Applicant: Konica Minolta, Inc., Tokyo (JP)

(72) Inventor: Yasuo SHIOKAWA, Tokyo (JP)

(21) Appl. No.: 17/371,828

(22) Filed: Jul. 9, 2021

(30) Foreign Application Priority Data
Jul. 10, 2020 (JP) 2020-119336

(51) Int. Cl. G03G 15/00; B65H 29/52; B65H 85/00

(52) U.S. Cl. CPC G03G 15/6576; B65H 85/00; B65H 29/52; G03G 15/6529

(57) ABSTRACT

An image forming apparatus includes: as a conveyance path to convey an object formed with an image by an image former, a bent conveyance path exhibiting a bent shape; and a straight conveyance path connected to a downstream side of the bent conveyance path and exhibiting a straight shape, wherein the bent conveyance path and the straight conveyance path each include: a pair of guide parts facing each other to form the bent conveyance path and the straight conveyance path; and a plurality of friction reducing parts that are arranged in a conveyance direction on one of a pair of the guide part and are able to abut with an image forming surface of the object conveyed between a pair of the guide parts.

### CROSS-REFERENCE TO RELATED APPLICATIONS

The present invention claims priority under 35 U.S.C. § 119 to Japanese Patent Application No. 2020-119336, filed on Jul. 10, 2020, the entire content of which is incorporated herein by reference.

### BACKGROUND

### Technological Field

The present invention relates to an image forming apparatus, more specifically, a conveyance path structure in which an object formed with an image is conveyed in the image forming apparatus.

### Description of the Related Art

JP 2016-061842 A describes an image forming apparatus provided with a movable roller, in order to inhibit image rubbing, at a bent portion of a conveyance path in which paper formed with an image is conveyed.

However, if low-temperature fixing of an image (toner) and a higher speed of paper conveyance are further promoted, paper may reach a guide part before the image on the paper solidifies, and the apparatus described in JP 2016-061842 A may not be able to inhibit image rubbing.

### SUMMARY

The present invention has been devised in view of the above circumstance, and an object is to provide an image forming apparatus capable of suitably inhibiting image rubbing.

To achieve the abovementioned object, according to an aspect of the present invention, an image forming apparatus reflecting one aspect of the present invention comprises: as a conveyance path to convey an object formed with an image by an image former, a bent conveyance path exhibiting a bent shape; and a straight conveyance path connected to a downstream side of the bent conveyance path and exhibiting a straight shape, wherein the bent conveyance path and the straight conveyance path each include: a pair of guide parts facing each other to form the bent conveyance path and the straight conveyance path; and a plurality of friction reducing parts that are arranged in a conveyance direction on one of a pair of the guide part and are able to abut with an image forming surface of the object conveyed between a pair of the guide parts.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a view schematically showing an image forming system according to an embodiment of the present invention;

FIG. 2 is a view schematically showing a conveyance path of an image forming apparatus according to an embodiment of the present invention;

FIG. 3 is a view schematically showing an example of a rotary member as a friction reducing part;

FIG. 4 is a view schematically showing an example of the rotary member as the friction reducing part;

FIG. 5 is a view schematically showing an example of the rotary member as the friction reducing part;

FIG. 6 is a view schematically showing an example of the rotary member as the friction reducing part;

FIG. 7 is a view schematically showing a bent conveyance path and a straight conveyance path provided with the rotary member as the friction reducing part;

FIG. 8 is a perspective view schematically showing the bent conveyance path provided with the rotary member as the friction reducing part; and

FIG. 9 is a cross-sectional view schematically showing the bent conveyance path provided with the rotary member as the friction reducing part.

### DETAILED DESCRIPTION OF EMBODIMENTS

Hereinafter, one or more embodiments of the present invention will be described with reference to the drawings. However, the scope of the invention is not limited to the disclosed embodiments. The same components are denoted by the same reference numerals, and redundant description will be omitted.

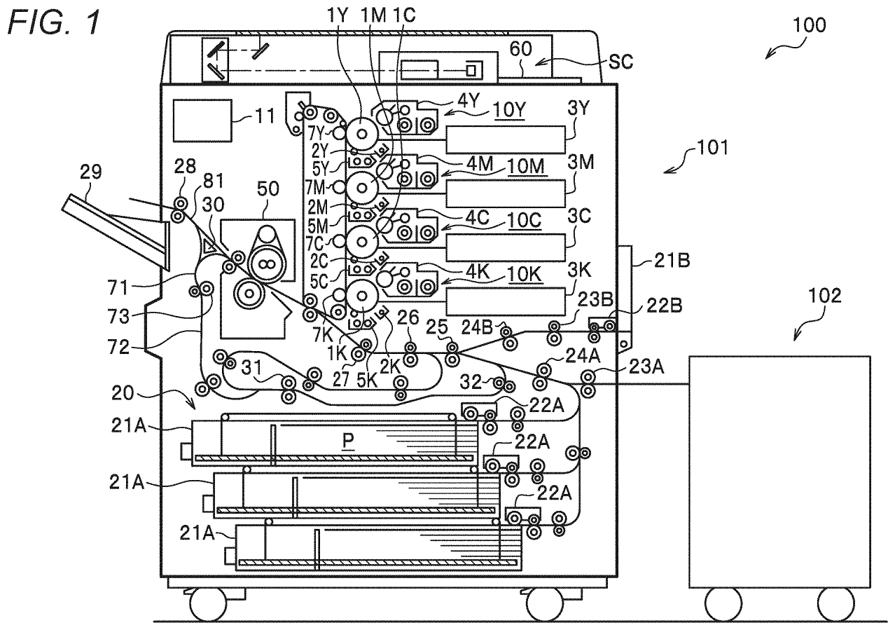

As shown in FIG. 1, an image forming system 100 according to an embodiment of the present invention includes: an image forming apparatus 101; and a paper feeding device 102 capable of supplying paper P to the image forming apparatus 101. The image forming apparatus 101 is an apparatus, such as a copying machine, that forms an image on the paper P as an object, by an electrophotographic method. The image forming apparatus 101 is a so-called tandem color image forming apparatus that forms a full-color image, by arranging a plurality of photoreceptors in a vertical direction to face one intermediate transfer belt.

The image forming apparatus 101 mainly includes a document reading device SC, four sets of image formers 10Y, 10M, 10C, and 10K, a fixing device 50, and a controller 11, which are housed in one housing.

The document reading device SC scans and exposes an image of a document by an optical system of a scanning exposure device, and reads the reflected light by a line image sensor, to obtain an image signal. This image signal is inputted to the controller 11 as image data after being subjected to processing such as A/D conversion, shading correction, and compression. The image data inputted to the controller 11 is not limited to the image data read by the document reading device SC, but may be, for example, received from a personal computer connected to the image forming apparatus 101 or from another image forming apparatus.

The four sets of image formers 10Y, 10M, 10C, and 10K include the image former 10Y that forms a yellow (Y) image, the image former 10M that forms a magenta (M) image, the image former 10C that forms a cyan (C) image, and the image former 10K that forms a black (K) image.

The image former 10Y includes a photoreceptor drum 1Y, a charging part 2Y arranged around the photoreceptor drum 1Y, an optical writing part 3Y, a developing device 4Y, and a drum cleaner 5Y. Similarly, the image formers 10M, 10C, and 10K include photoreceptor drums 1M, 1C, and 1K, charging parts 2M, 2C, and 2K arranged around the photoreceptor drums 1M, 1C, and 1K, optical writing parts 3M, 3C, and 3K, developing devices 4M, 4C, and 4K, and drum cleaners 5M, 5C, and 5K.

Surfaces of the photoreceptor drums 1Y to 1K are uniformly charged by the charging parts 2Y to 2K, and a latent image is formed on the photoreceptor drums 1Y to 1K by scanning exposure by the optical writing parts 3Y to 3K. Further, the developing devices 4Y to 4K visualize the latent image on the photoreceptor drums 1Y to 1K by developing with toner. This causes formation of a toner image of a predetermined color corresponding to any of yellow, magenta, cyan, and black, on the photoreceptor drums 1Y to 1K. The toner images formed on the photoreceptor drums 1Y to 1K are sequentially transferred to a predetermined position on a rotating intermediate transfer belt 6, by primary transfer rollers 7Y, 7M, 7C, and 7K.

The toner image made by each color and transferred on the intermediate transfer belt 6 is transferred by a transfer roller 9, to the paper P conveyed at a predetermined timing by a paper conveyance part 20 described later. The transfer roller 9 is arranged so as to be in pressure contact with the intermediate transfer belt 6.

The paper conveyance part 20 conveys the paper P in accordance with a conveyance path of the paper P defined in the machine. The paper P is housed in a paper feeding tray 21A, and the paper P housed in the paper feeding tray 21A is taken in by a paper feeding part 22A and sent out to the conveyance path. Alternatively, the paper P is housed in a paper feeding tray included in the paper feeding device 102 connected to the image forming apparatus 101, and the paper P held by the paper feeding device 102 is supplied from the paper feeding device 102 to the image forming apparatus 101, to be sent out to the conveyance path.

In this conveyance path, on an upstream side from a transfer position where the toner image is transferred to the paper P (that is, a pressure contact position between the intermediate transfer belt 6 and the secondary transfer roller 9), a plurality of conveyors that convey the paper P are provided. Each conveyor includes a pair of pressure-contacted rollers, and conveys the paper P by rotationally driving at least one of the rollers through a driving unit such as an electric motor. Further, the pair of rollers included in the conveyor are configured such that a pressure contact state between the rollers can be switched to a separated state as needed.

In the present embodiment, from an upstream side to a downstream side in a paper conveyance direction, intermediate conveyance rollers 23A, 24A, and 25, a loop roller 26, and a resist roller 27 are provided as the conveyor. In addition to the conveyor including a pair of rollers, it is possible to widely adopt a configuration in which the paper P is conveyed by having a pair of rotary members, such as a combination of belts or a combination of a belt and a roller, and rotationally driving the rotary members.

The conveyance path of the paper P is formed by a guide member that guides conveyance of the paper P. This guide member includes a pair of guide plates arranged facing each other at a predetermined distance so as to face both sides of the conveyed paper P. However, since this guide member can be replaced by a switching member that switches the paper conveyance direction or by another member, one guide plate may be provided on one side alone of the paper P to form a conveyance path, without necessarily including the pair of guide plates.

Further, in the present embodiment, the predetermined guide plate is provided with a bent portion on an upstream side from the intermediate conveyance roller 25, to form a conveyance path that is bent (hereinafter referred to as “bent conveyance path”). For example, the bent conveyance path is formed between the intermediate conveyance roller 23A on an upstream side and the intermediate conveyance roller 24A on a downstream side.

In such a conveyance path, the paper P fed from the paper feeding tray 21A or the paper feeding device 102 is sequentially conveyed by the plurality of intermediate conveyance rollers 23A, 24A, and 25 and the loop roller 26 provided from the upstream side to the downstream side, to advance in the conveyance path. Next, before a tip end of the paper P reaches the resist roller 27, the conveyor on the upstream side from the loop roller 26, specifically, the intermediate conveyance rollers 23A, 24A, and 25 are switched from the pressure contact state to the separated state. Therefore, after the intermediate conveyance rollers 23A, 24A, and 25 transition to the separated state, the paper P is conveyed by the loop roller 26 alone. After that, the paper P conveyed by the loop roller 26 is abutted against the resist roller 27 in a rotation stop state, and then the loop roller 26 continues to rotate for a predetermined time to form a loop on the paper P. The action of this loop formation corrects skew of the paper P (skew correction).

Next, when the resist roller 27 starts rotating at a predetermined timing synchronized with a toner image on the intermediate transfer belt 6, the loop roller 26 is switched from a pressure contact state to a separated state as in the intermediate conveyance rollers 23 to 25. That is, after the loop roller 26 transitions to the separated state, the paper P is conveyed by the resist roller 27 alone. This resist roller 27 conveys the paper P to a transfer position while performing swing processing described later while conveying the paper P.

The resist roller 27 is able to swing along a paper width direction CD (a direction orthogonal to a paper conveyance direction FD). This resist roller 27 is connected with a drive mechanism, and can move along the paper width direction CD by being driven by the drive mechanism. Therefore, by moving along the paper width direction CD in accordance with a passing period in which the paper P passes through the resist roller 27, the resist roller 27 can move the conveyed paper P along the paper width direction CD (the swing processing of the paper P). This allows the resist roller 27 to adjust such that a conveyance position of the paper P matches a position of a transferred toner image in the paper width direction CD.

The individual rollers 23A, 24A, 25 to 27 that have been switched to the separated state are switched to the pressure contact state after the paper P has passed through the resist roller 27, or before the subsequent paper P reaches their own rollers. Note that, the swing processing of the paper P by the resist roller 27 is not always necessary to be executed when the position matches the toner image, when operating conditions for regulating execution of swing processing are satisfied, when a user does not want the swing processing, and the like, and it suffices that the swing processing is executed as required.

The fixing device 50 is a device that fixes a toner image on the paper P on which the toner image is transferred by the transfer roller 9. For example, the fixing device 50 includes a pair of fixing members (for example, a pair of rollers) forming a fixing nip part, and a heater to heat one or both of the fixing members. In this fixing device 50, when the paper P passes through the fixing nip part in a conveyance process of the paper P, a toner image is fixed on the paper P through an action of pressurization by the pair of fixing members and the heat of the fixing members.

The paper P subjected to fixing processing by the fixing device 50 is discharged by a paper discharging roller 28 to a paper discharging tray (discharging tray) 29 attached to an outer side surface of the housing. Further, for also forming an image on a back surface of the paper P, the paper P having finished with image formation on a paper front surface is conveyed by a switching gate 30 to a reversing roller 31 below. The reversing roller 31 sandwiches a rear end of the conveyed paper P and then reversely feeds to reverse the paper P, and feeds to a re-feeding conveyance path. The paper P fed to the re-feeding conveyance path is conveyed by a plurality of re-feeding conveyors, and the paper P is returned to the transfer position. The paper discharging roller 28, the switching gate 30, the reversing roller 31, and the re-feeding conveyor are also included in the paper conveyance part 20.

The controller 11 has a function of controlling the image forming apparatus in an integrated manner. Further, the controller 11 is a computer equipped with a CPU, memory such as ROM and RAM, a hard disk drive (HDD) as an auxiliary storage device, a communication I/F unit, and the like, and these elements are connected to each other via a bus.

By controlling each part of the image forming apparatus (for example, the image formers 10Y to 10K, the paper conveyance part 20, the fixing device 50, and the like), the controller 11 executes each process shown below to form a toner image on the paper P.

(1) Charging the photoreceptor drums 1Y to 1K

(2) Forming an electrostatic latent image on the photoreceptor drums 1Y to 1K by the optical writing parts 3Y to 3K

(3) Attaching toner to the formed electrostatic latent image

(4) Primarily transferring the toner image on the photoreceptor drums 1Y to 1K, onto the intermediate transfer belt 6

(5) Conveying the paper P by the paper conveyance part 20

(6) Secondarily transferring the toner image on the intermediate transfer belt 6, onto the paper P

(7) Performing fixing processing by the fixing device 50 on the toner image transferred to the paper P

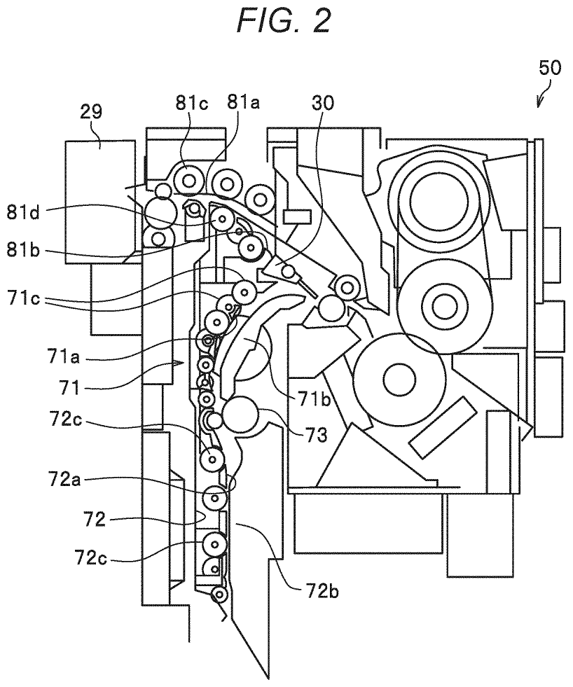

As shown in FIG. 2, the image forming apparatus 101 includes a bent conveyance path 71 provided on one side on a downstream side of the switching gate 30, a straight conveyance path 72, and a discharge conveyance path 81 provided on another side on the downstream side of the switching gate 30, as a path to convey an object (the paper P) formed with an image by the image formers 10Y, 10M, 10C, and 10K on a downstream side of the fixing device 50. The bent conveyance path 71 and the straight conveyance path 72 are re-feeding conveyance paths to reverse and return the paper P to the image formers 10Y, 10M, 10C, and 10K. The discharge conveyance path 81 is a path to convey the paper P to the paper discharging tray 29.

### Switching Gate

The switching gate 30 is provided at a three-way junction connected to the bent conveyance path 71 and the discharge conveyance path 81, on a downstream side of the image former 10Y to 10K (the fixing device 50 in the present embodiment). The switching gate 30 switches, on the basis of the control by the controller 11, between a state where the paper P is conveyed to the bent conveyance path 71 by opening the bent conveyance path 71 side and blocking the discharge conveyance path 81 side, and a state where the paper P is conveyed to the discharge conveyance path 81 by blocking the bent conveyance path 71 side and opening the discharge conveyance path 81 side.

### Bent Conveyance Path

The bent conveyance path 71 is a path to convey the paper P having passed through the switching gate 30, while changing a direction from a diagonally upward direction to downward by exhibiting a bent shape, and includes a pair of guide parts 71a and 71b facing each other. The guide parts 71a and 71b are resin or metal plate-shaped members (guide plates) arranged with a guide gap.

### Straight Conveyance Path

The straight conveyance path 72 is a path to convey the paper P having passed through the bent conveyance path 71 downward by exhibiting a substantially straight shape, and includes a pair of guide parts 72a and 72b facing each other. The guide parts 72a and 72b are resin or metal plate-shaped members (guide plates) arranged with a guide gap. The straight conveyance path 72 has a larger radius of curvature than that of the bent conveyance path 71, and may be regarded as having a substantially linear shape. Further, the straight conveyance path 72 may have a portion exhibiting a bent shape in at least one of both end parts in the conveyance direction.

### Decurler

At a connection portion between the bent conveyance path 71 and the straight conveyance path 72, a decurler 73 is provided. The decurler 73 is a roller to correct a shape (eliminate a curvature) of the paper P passing through the decurler 73.

### Discharge Conveyance Path

The discharge conveyance path 81 is a path to convey the paper P having passed through the switching gate 30 to the paper discharging tray (discharging tray) 29, while changing a direction from a diagonally upward direction to a substantially horizontal direction, and includes a pair of upper and lower guide parts 81a and 81b facing each other. The guide parts 81a and 81b are resin or metal plate-shaped members (guide plates) arranged with a guide gap.

### Friction Reducing Part

To such the conveyance paths 71, 72, and 81, a plurality of friction reducing parts 71c, 72c, 81c, and 81d are provided. Frictional resistance generated between the paper P and the friction reducing parts 71c, 72c, 81c, and 81d is smaller than frictional resistance generated between the paper P and the guide parts provided with the friction reducing parts 71c, 72c, 81c, and 81d. The friction reducing parts 71c, 72c, 81c, and 81d are provided so as to be housed in recesses of the respective guide parts (or outside the conveyance path of the guide parts). The friction reducing parts 71c, 72c, 81c, and 81d are rotary members (rollers, bearings, and the like) that are rotatable around an axis that is parallel to a guide surface of the guide part and orthogonal to the conveyance direction of the paper P The friction reducing parts 71c, 72c, 81c, and 81d are provided so as to partially protrude into the conveyance path through a hole or the like formed on the guide part, and rotate by abutting with the paper P located in the conveyance path, to passively convey the paper P.

### Example of Friction Reducing Part (Rotary Member)

Here, specific examples of the friction reducing parts 71c, 72c, 81c, and 81d will be described.

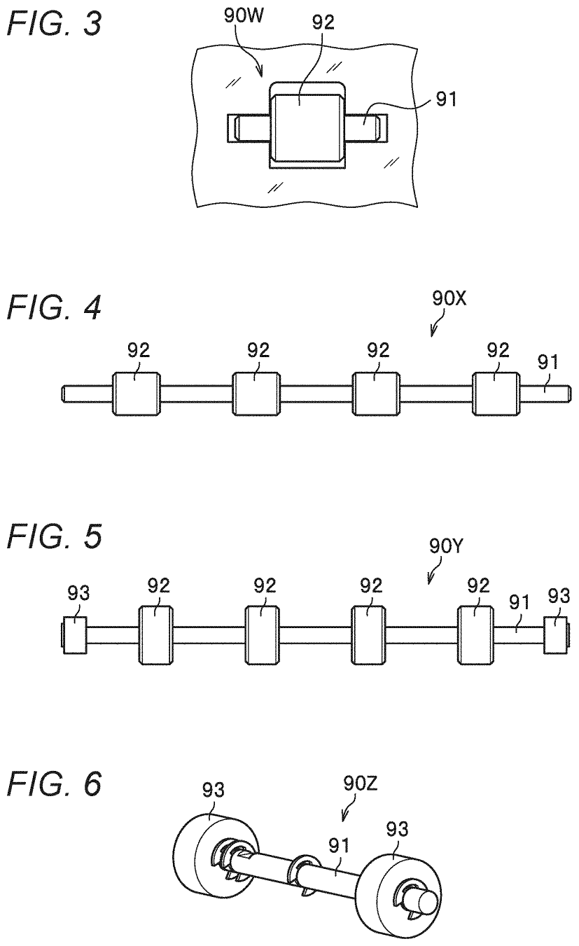

As shown in FIG. 3, a friction reducing part 90W according to an example includes a shaft part 91 and one roller (a large diameter part) 92 provided to the shaft part 91. Both end parts of the shaft part 91 are non-rotatably held by the guide part, and the roller 92 rotates with respect to the shaft part 91. Meanwhile, both end parts of the shaft part 91 may be rotatably held by the guide part, and the shaft part 91 and the roller 92 may be integrally rotated.

As shown in FIG. 4, a friction reducing part 90X according to another example includes a shaft part 91 and a plurality of rollers (large diameter parts) 92 provided to the shaft part 91. Both end parts of the shaft part 91 are non-rotatably held by the guide part, and the plurality of rollers 92 rotate with respect to the shaft part 91. Meanwhile, both end parts of the shaft part 91 may be rotatably held by the guide part, and the shaft part 91 and the plurality of rollers 92 may be integrally rotated.

As shown in FIG. 5, a friction reducing part 90Y according to another example includes a shaft part 91, one roller (a large diameter part) 92 provided to the shaft part 91, and a bearing 93 provided at both end parts of the shaft part 91. Both end parts of the shaft part 91 are rotatably held by the guide part via the bearing 93, and the shaft part 91 and the plurality of rollers 92 rotate integrally.

As shown in FIG. 6, a friction reducing part 90Z according to another example may have a configuration including a shaft part 91 and one or more bearings 93 provided to the shaft part 91. The shaft part 91 is non-rotatably held by the guide part, and an outer peripheral part of the bearing 93 rotates with respect to the shaft part 91.

Note that, as is the friction reducing part 90X and 90Y, a friction reducing part provided with a plurality of rollers or the like (a main body of the friction reducing part) for one shaft is suitable for providing a plurality of friction reducing parts in a width direction of the paper P. Further, in such the friction reducing part, since the main body of the friction reducing part is rotatable independently, it is possible to suitably carry out conveyance according to an abutting state with the paper P. In addition, such the friction reducing part can suitably realize a dense arrangement in the bent conveyance path 71 described later, by shifting a position of the roller and the like (the main body of the friction reducing part) in the conveyance direction, to the width direction of the paper P (a direction orthogonal to the conveyance direction in the conveyance path).

### Friction Reducing Part of Bent Conveyance Path

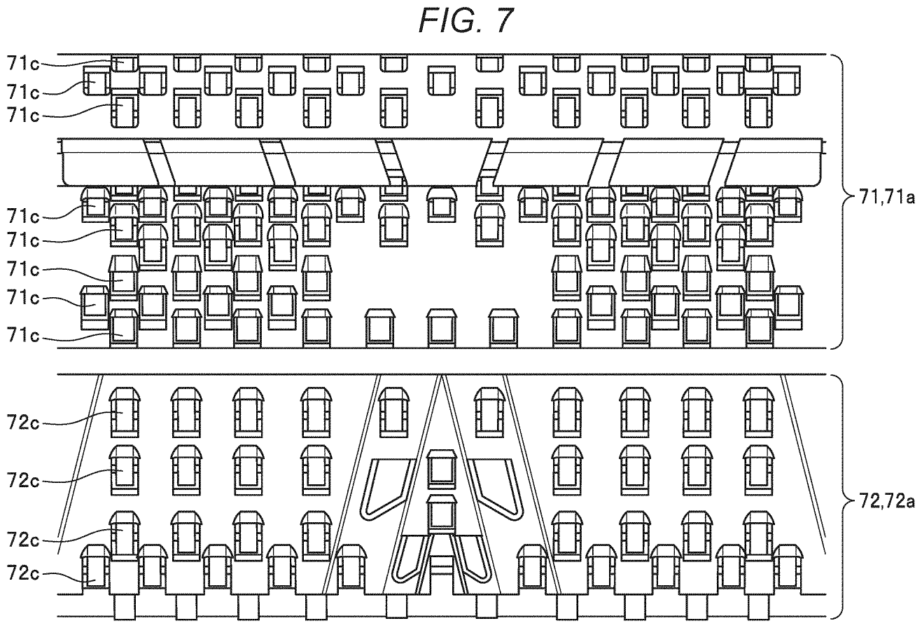

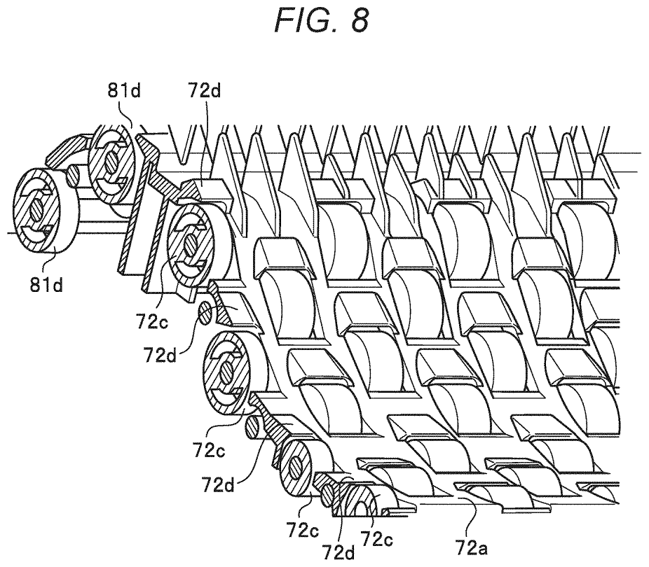

As shown in FIG. 2, FIG. 7 and FIG. 8, the bent conveyance path 71 is provided with a plurality of friction reducing parts 71c. The friction reducing part 71c is provided to the guide part 71a on an outer side of the bend. The guide part 71a faces an image forming surface of the paper P.

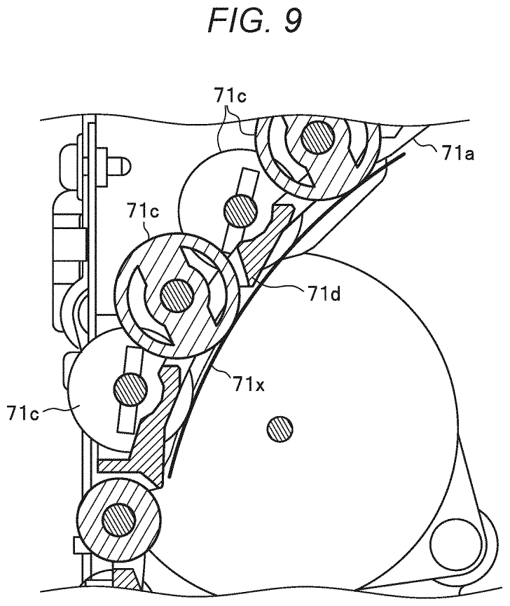

The plurality of friction reducing parts 71c are individually arranged in the conveyance direction and in a direction orthogonal to the conveyance direction. The plurality of friction reducing parts 71c arranged in the conveyance direction are overlapped with each other in side view (when viewed from the direction orthogonal to the conveyance direction). More specifically, in the plurality of friction reducing parts 71c arranged in the conveyance direction, parts protruding into the conveyance path 71 are not overlapped (are separated) in side view, while parts located outside the conveyance path 71 are overlapped in side view (see FIG. 9). That is, in the bent conveyance path 71, the plurality of friction reducing parts 71c are densely arranged in zigzag (in the conveyance direction, as compared with the straight conveyance path 72).

In recent years, low temperature fixing of toner has been carried out in order to realize energy saving. In this case, even if a temperature of the paper P is the same, the toner becomes soft and does not solidify, which deteriorates resistance against friction. Here, in order to increase the resistance of the toner against friction, it is necessary to extend time for cooling the paper P and the toner, which lengthens the conveyance path between the fixing device 50 and the bent conveyance path 71, resulting in an increase in the size of the apparatus. On the other hand, in the image forming apparatus 101, when the bent conveyance path 71 is provided on the downstream side near the fixing device 50, a load (a force of removing an image from the object due to friction or the like) generated between the bent conveyance path and the image forming surface of the object is set smaller than a holding force of the image formed on the object (a force of allowing the image to remain on the object, against friction or the like) by the bent conveyance path 71 having the friction reducing part 71c. This can inhibit image rubbing (toner peeling, scratches, and the like) without causing an increase in size of the apparatus.

The guide part 71a is formed with an eaves part 71d that covers an upstream end part of the friction reducing part 71c. The eaves part 71d overlaps with the corresponding friction reducing part 71c when viewed from a normal direction (the conveyance path 71 side) of the guide part 71a. A protruding height of the eaves part 71d from the guide part 71a is smaller than a protruding height of the friction reducing part 71c from the guide part 71a. In other words, the eaves part 71d is located on the guide part 71a side from a curve 71x connecting apexes, protruding from the guide part 71a, of the friction reducing parts 71c arranged in the conveyance direction (does not exceed the curve 71x) (see FIG. 9).

The paper P conveyed in the bent conveyance path 71 is conveyed while abutting with the plurality of friction reducing parts 71c. This inhibits abutting of the image forming surface of the paper P with the guide part 71a. Further, the eaves part 71d inhibits that the paper P is caught by the friction reducing part 71c.

### Friction Reducing Part of Straight Conveyance Path

As shown in FIG. 2 and FIG. 7, the straight conveyance path 72 is provided with a plurality of friction reducing parts 72c. The friction reducing part 72c is provided to the guide part 72a continuous with the guide part 71a on an outer side of the bend. The guide part 72a faces an image forming surface of the paper P.

The plurality of friction reducing parts 72c are individually arranged in the conveyance direction and in a direction orthogonal to the conveyance direction. The plurality of friction reducing parts 72c arranged in the conveyance direction are not overlapped with each other (are separated) in side view (when viewed from the direction orthogonal to the conveyance direction). That is, in the straight conveyance path 72, the plurality of friction reducing parts 72c are coarsely arranged (in the conveyance direction, as compared with the bent conveyance path 71).

The guide part 72a is formed with an eaves part 72d that covers an upstream end part of the friction reducing part 72c. A protruding height of the eaves part 72d from the guide part 72a is smaller than a protruding height of the friction reducing part 72c from the guide part 72a. In other words, the eaves part 72d is located on the guide part 72a side from a curve connecting apexes, protruding from the guide part 72a, of the friction reducing parts 72c arranged in the conveyance direction (does not exceed the curve).

The paper P conveyed in the straight conveyance path 72 is conveyed while abutting with the plurality of friction reducing parts 72c. This inhibits abutting of the image forming surface of the paper P with the guide part 72a. Further, the eaves part 72d inhibits that the paper P is caught by the friction reducing part 72c.

### Friction Reducing Part of Discharge Conveyance Path

As shown in FIG. 2, the discharge conveyance path 81 is provided with a plurality of friction reducing parts 81c and 81d. The friction reducing parts 81c and 81d are provided to both guide parts 81a and 81b, respectively. The upper guide part 81a faces the image forming surface of the paper P when an image is formed on one side alone. The lower guide part 81b faces another image forming surface of the paper P when an image is formed on both sides.

The plurality of friction reducing parts 81c provided to the upper guide part 81a are individually arranged in the conveyance direction and in a direction orthogonal to the conveyance direction. The plurality of friction reducing parts 81c arranged in the conveyance direction are not overlapped with each other (are separated) in side view (when viewed from the direction orthogonal to the conveyance direction).

The plurality of friction reducing parts 81d provided to the lower guide part 81b are individually arranged in the conveyance direction and a direction orthogonal to the conveyance direction. The plurality of friction reducing parts 81c arranged in the conveyance direction are overlapped with each other in side view (when viewed from the direction orthogonal to the conveyance direction).

More specifically, in the plurality of friction reducing parts 81d arranged in the conveyance direction, parts protruding into the conveyance path 81 are not overlapped (are separated) in side view, while parts located outside the conveyance path 81 are overlapped in side view.

The paper P conveyed in the discharge conveyance path 81 is conveyed while abutting with the plurality of friction reducing parts 81c and 81d. This inhibits abutting of the image forming surface of the paper P with the guide parts 81a and 81b. The guide parts 81a and 81b may have eaves parts similar to the eaves part 71d and 72d described above.

The image forming apparatus 101 according to the embodiment of the present invention includes: the bent conveyance path 71 exhibiting a bent shape; and the straight conveyance path 72 connected to the downstream side of the bent conveyance path 71 and exhibiting a straight shape, as a conveyance path to convey an object (the paper P) formed with an image by the image formers 10Y, 10M, 10C, and 10K. The bent conveyance path 71 and the straight conveyance path 72 each include: a pair of the guide parts 71a, 71b, 72a, and 72b facing each other to form the bent conveyance path 71 and the straight conveyance path 72; and a plurality of friction reducing parts 71c and 72c that are arranged in the conveyance direction on one of the pair of guide parts 71a, 71b, 72a, and 72b and can abut with an image forming surface of the object conveyed between a pair of the guide parts.

Therefore, the image forming apparatus 101 can suitably inhibit image rubbing while realizing low-temperature fixing of an image (toner) and a higher speed of paper conveyance.

In the image forming apparatus 101, a load generated between the bent conveyance path 71 and an image forming surface of the object is smaller than a holding force of an image formed on the object.

Therefore, the image forming apparatus 101 can inhibit image rubbing (toner peeling, scratches, and the like) without causing an increase in size of the apparatus.

In the image forming apparatus 101, the bent conveyance path 71 is located on the downstream side of the switching gate 30 that switches between conveying the object formed with an image to the discharging tray 29 and conveying to the bent conveyance path 71 and the straight conveyance path 72 for re-conveyance to the image formers 10Y, 10M, 10C, and 10K.

Therefore, the image forming apparatus 101 can suitably inhibit image rubbing while realizing low-temperature fixing of an image (toner) and a higher speed of paper conveyance, in the conveyance path when an image is formed on another side of the object formed with an image on one side.

The image forming apparatus 101 includes, as the conveyance path, the discharge conveyance path 81 provided between the switching gate 30 and the discharging tray 29. The discharge conveyance path 81 includes: a pair of guide parts 81a and 81b facing each other and forming the discharge conveyance path 81; and a plurality of friction reducing parts 81c and 81d that are arranged in the conveyance direction on both of the pair of the guide parts 81a and 81b and can abut with the object conveyed between a pair of the guide parts 81a and 81b.

Therefore, the image forming apparatus 101 can inhibit image rubbing while realizing low-temperature fixing of an image (toner) and a higher speed of paper conveyance, also in the conveyance path when the object formed with an image on both sides is discharged.

The friction reducing parts 71c and 72c (81c and 81d) are rotary members that are rotatable by abutting with the object.

Therefore, the image forming apparatus 101 can realize the friction reducing parts 71c and 72c (81c and 81d) with a simple configuration.

In the image forming apparatus 101, with respect to the plurality of rotary members arranged in the conveyance direction, parts protruding into the conveyance path are separated from each other in side view, while parts located outside the conveyance path are overlapped each other in side view.

Therefore, the image forming apparatus 101 can suitably inhibit image rubbing by arranging the friction reducing parts, that is, the rotary members densely in the conveyance direction.

In the bent conveyance path 71 of the image forming apparatus 101, with respect to the plurality of rotary members arranged in the conveyance direction, parts protruding into the conveyance path 71 are separated from each other in side view, while parts located outside the conveyance path 71 are overlapped each other in side view. In the straight conveyance path 72, the plurality of rotary members arranged in the conveyance direction are separated from each other in side view.

Therefore, the image forming apparatus 101 suitably inhibits image rubbing by arranging the friction reducing parts, that is, the rotary members relatively densely in the conveyance direction in the bent conveyance path 71 in which a conveyance load is relatively large, and can inhibit image rubbing while reducing the number of rotary members by arranging the friction reducing parts, that is, the rotary members relatively coarsely in the conveyance direction in the straight conveyance path 72 in which a conveyance load is relatively small.

In the image forming apparatus 101, the guide parts 71a and 72a include the eaves parts 71d and 72d that cover the upstream end part of the rotary member.

Therefore, the image forming apparatus 101 can inhibit that the object is caught by the rotary member, and can suitably convey the object, even when a diameter of the friction reducing part, that is, a diameter of the rotary member is small.

In the image forming apparatus 101, a protruding height of the eaves part 71d and 72d from the guide parts 71a and 72a is smaller than a protruding height of the rotary member from the guide parts 71a and 72a.

Therefore, the image forming apparatus 101 can inhibit abutting of the object with the eaves part 71d and 72d, and can suitably convey the object.

In the image forming apparatus 101, the decurler 73 that corrects a shape of the object is provided between the bent conveyance path 71 and the straight conveyance path 72.

Therefore, the image forming apparatus 101 can arrange the decurler 73 close to the image former, and can reduce a load on the object after passing through the decurler 73.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming apparatus comprising:
as a conveyance path to convey an object formed with an image by an image former,
a bent conveyance path exhibiting a bent shape; and
a straight conveyance path connected to a downstream side of the bent conveyance path and exhibiting a straight shape, wherein
the bent conveyance path and the straight conveyance path each include: a pair of guide parts facing each other to form the bent conveyance path and the straight conveyance path; and a plurality of friction reducing parts that are arranged in a conveyance direction on one of a pair of the guide part and are able to abut with an image forming surface of the object conveyed between a pair of the guide parts.

2. The image forming apparatus according to claim 1, wherein
a load generated between the bent conveyance path and the image forming surface of the object is smaller than a holding force of an image formed on the object.

3. The image forming apparatus according to claim 1, wherein
the bent conveyance path is located on a downstream side of a switching gate that switches between conveying the object formed with an image to the discharging tray and conveying to the bent conveyance path and the straight conveyance path for re-conveyance to the image former.

4. The image forming apparatus according to claim 3, further comprising:
a discharge conveyance path, as the conveyance path, provided between the switching gate and a discharging tray, wherein
the discharge conveyance path includes: a pair of guide parts facing each other and forming the discharge conveyance path; and a plurality of friction reducing parts that are arranged in a conveyance direction on both of a pair of the guide parts and are able to abut with the object conveyed between a pair of the guide parts.

5. The image forming apparatus according to claim 1, wherein
the friction reducing parts are rotary members that are rotatable by abutting with the object.

6. The image forming apparatus according to claim 5, wherein
with respect to a plurality of the rotary members arranged in a conveyance direction,
parts protruding into the conveyance path are separated from each other in side view, and
parts located outside the conveyance path are overlapped each other in side view.

7. The image forming apparatus according to claim 5, wherein
in the bent conveyance path, with respect to a plurality of the rotary members arranged in a conveyance direction, parts protruding into the conveyance path are separated from each other in side view, and parts located outside the conveyance path are overlapped each other in side view, and
in the straight conveyance path, a plurality of the rotary members arranged in a conveyance direction are separated from each other in side view.

8. The image forming apparatus according to claim 5, wherein
each of the guide parts includes an eaves part that covers an upstream end part of each of the rotary members.

9. The image forming apparatus according to claim 8, wherein
a protruding height of the eaves part from each of the guide parts is smaller than a protruding height of each of the rotary members from each of the guide parts.

10. The image forming apparatus according to claim 1, wherein
between the bent conveyance path and the straight conveyance path, a decurler that corrects a shape of the object is provided.
